(19) United States
(12) Patent Application Publication
(10) Pub. No.: US 2003/0188200 A1
(43) Pub. Date: Oct. 2, 2003

(54) Processes, apparatus and systems for secure messaging

(76) Inventors: Anthony Paquin, Post Falls, ID (US); Colin Christie, Cave Creek, AZ (US); Russell Reese, Post Falls, ID (US)

Correspondence Address: WELLS ST. JOHN P.S., 601 W. FIRST AVENUE, SUITE 1300, SPOKANE, WA, 99201, US

(21) Appl. No.: 10/107,935

(22) Filed: Mar. 26, 2002

(51) Int. Cl. H04L 9/00

(52) U.S. Cl. 713/202

(57) ABSTRACT

A process for rendering confidential data available for review includes sending a notice to an intended recipient to advise them of the existence of a confidential record in an electronic mailbox associated with the intended recipient, receiving a password associated with the electronic mailbox containing the confidential record in response to sending and transmitting an electronic signal representing the confidential record over a secure web connection.

### TECHNICAL FIELD

This invention relates to processes, apparatus and systems for secure messaging applications. In a more specific aspect, the present invention relates to processes, apparatus and systems for secure messaging with respect to legally significant documents or proprietary documents, for example, relating to medical information.

### BACKGROUND OF THE INVENTION

In recent years, legislation has been adopted in at least one country, the USA, relating to disclosure standards with respect to medical information. More specifically, Congress and the House adopted legislation in 1996 relating to the Health Insurance Portability and Accountability Act or HIPAA.

These regulations present new privacy requirements with respect to use and disclosure of health- and treatment-related information by health care providers and parties affiliated with health care provision, such as health plans, insurance providers, health care clearinghouses, employer and other parties providing services to or related to these entities. These regulations are described, at least in part, in Title 45 of the Code of Federal Regulations or CFR.

The Health and Human Services office provides web access to such regulations at least in part at the web address http://aspe.os.dhhs.gov/admnsimp/final/PvcTxt01.htm. The Final Privacy Rules from this agency go into effect in February of 2003.

For the healthcare industry, these new regulations and statutes have major implications relating to handling of medical records and records related to health care. Compliance with these considerations affects patients, providers and payors, and influences the choice of equipment that is employed for handling of such information.

Today, millions of people and institutions use email or other web-based or intranet-based communications as daily forms of communication. Surveys have provided date suggesting that about 15% of physicians reported using email to send patient specific data clinical information to one or more locations. About another 40% indicated that they did not, at that time, use these protocols, but indicated that they would do so if security and integrity of data communications achievable by these protocols were demonstrated and guaranteed.

Furthermore, there are growing needs for convenience and efficiency that could be achieved via electronic communications such as email and web-based access that could be realized through such processes. Doctors, nurses and other health care personnel could realize enormous productivity gains via electronic communication of patient treatment, diagnosis and ancillary information over an easily-accessed and utilized medium without compromise of information integrity and security.

The vast majority of email ultimately traverses a non-secure data communications path, such as the Internet. Broad use of current email system for medical data transmission could be flagrant violations of the spirit and intent of the medical privacy regulations such as HIPAA.

Accordingly, this invention arose out of concerns related at least in part to providing secure systems, processes and apparatus for messaging related to legally-significant data such as medical records.

### SUMMARY OF THE INVENTION

In one aspect, the present invention includes a process for reviewing confidential data. The process includes receiving a message including notification that a confidential record has been created and accessing the confidential record using a predetermined protocol and password.

In another aspect, the present invention includes a process for rendering confidential data available for review includes sending a notice to an intended recipient to advise them of the existence of a confidential record in an electronic mailbox associated with the intended recipient, receiving a password associated with the electronic mailbox containing the confidential record in response to sending and transmitting an electronic signal representing the confidential record over a secure web connection.

In a further aspect, the present invention includes a process for creating a new entry in a secure database. The process includes entering addressing data specific to a particular person in an address table stored on a computer database. The process also includes entering data allowing routing of messages to one or more parties associated with healthcare for the particular person in the address table and linked to confidential records associated with the particular person. The process also includes establishing passwords configured to allow access to confidential records for the particular person, wherein the passwords are configured to provide indicia permitting identification of the one or more parties when the one or more parties access the confidential records for security and audit purposes.

In yet a further aspect, the present invention includes a process of communicating medical data between parties. The process includes receiving a request to access a secure database via a secure web connection, accepting first predetermined data indicative of an electronic mailbox and second predetermined data indicative of a confidential record comprising medical data relevant to a specific patient and transmitting an electronic signal representing a portion of the confidential record over the secure web connection.

In yet another aspect, the present invention includes an article of manufacture comprising a computer readable medium having computer readable code embodied therein for a process for rendering confidential data available for review. The computer readable code is configured to cause a processor to send a notice to an intended recipient to advise them of the existence of a confidential record in an electronic mailbox associated with the intended recipient, receive a password associated with the electronic mailbox containing the confidential record in response to sending and transmit an electronic signal representing the confidential record over a secure web connection.

In an additional aspect, the present invention includes an article of manufacture comprising a computer readable medium having computer readable code embodied therein for a process for creating a new entry in a secure database. The computer readable code is configured to cause a processor to enter addressing data specific to a particular person in an address table stored on a computer database, enter data allowing routing of messages to one or more parties associated with healthcare for the particular person in the address table and linked to confidential records associated with the particular person and establish passwords configured to allow access to confidential records for the particular person, wherein the passwords are configured to provide indicia permitting identification of the one or more parties when the one or more parties access the confidential records for security and audit purposes.

### BRIEF DESCRIPTION OF THE DRAWINGS

Preferred embodiments of the invention are described below with reference to the following accompanying drawings.

FIG. 1 is a simplified block diagram of a computer network including a computer, a display device and a database, in accordance with an embodiment of the present invention.

FIG. 2 is a flow chart describing a process for reviewing confidential data using a computer system such as the one of FIG. 1, in accordance with an embodiment of the present invention.

FIG. 3 is a flow chart describing a process for rendering confidential data available for review using a computer system such as the one of FIG. 1, in accordance with an embodiment of the present invention.

FIG. 4 is a flow chart describing a process for creating a new entry in a secure database using a computer system such as the one of FIG. 1, in accordance with an embodiment of the present invention.

### DETAILED DESCRIPTION OF THE PREFERRED EMBODIMENTS

The various inventive embodiments described below advantageously meet the needs of patients and healthcare professionals by providing secure systems and processes for medical messaging. In addition, the embodiments comply with HIPAA requirements. The inventive embodiments interact synergistically using existing electronic messaging systems, such as email systems, so that those who use the systems do not need to be concerned with an additional level of complexity. The embodiments also ensure that medical record-related communications remain in a secure environment and can provide an audit trail showing who accessed data, what data were accessed and when the data were accessed. The inventive system requires little or no technical expertise by users. This is advantageous from the standpoint of appealing to a wide range of users who need not be computer experts.

In one embodiment, messages containing medical or medical-related information that have been created are retained in a server at a secure web site location. Rather than transmitting those messages over non-secure Internet connections, the system sends Notices to participants alerting them to the fact that they have a message that they need to access that is being stored on the secure server. The participants then can connect to the secure server using secure techniques (e.g., via a conventional secure, 128 bit Secure Sockets Layer (SSL) protocol, which may be mandated by statute) to view, edit, send and reply to messages. In one embodiment, messages may not be emailed outside of the secure web site, and may only be sent to predetermined addresses within the secure web site.

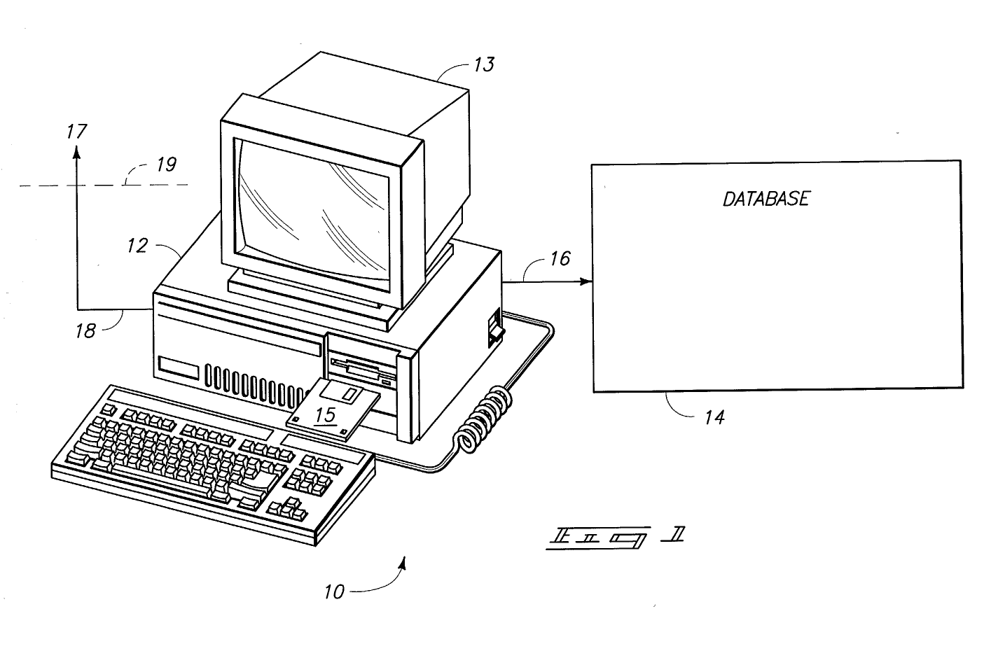

An example of a computer capable of operating in accordance with the system as a repository of confidential data is shown in FIG. 1. FIG. 1 is a simplified block diagram of a computer network 10 including a computer 12, a display device 13 and a database 14, in accordance with an embodiment of the present invention. The computer 12 is coupled to the database 14 via a bus 16 allowing either the computer 12 or the database 14 to initiate data communications with the other. In one embodiment, the database 14 is a device such as a hard drive, zip drive or other robust, non-volatile data storage device. The computer 12 also includes non-volatile memory capable of reading computer code embodied in a memory device such as a floppy disc 15, CD-ROM, magneto-optical memory device, DVD-ROM or other article of manufacture, including EEPROM, ROM or other semiconductor memory device, wherein the computer code may include data or instructions configured to cause a processor to execute processes such as those described herein.

It will be appreciated that while FIG. 1 illustrates only a single computer 12 and database 14 for ease of illustration and convenience in understanding, multiple computers 12 and databases 14 may all be coupled to the bus 16.

In one embodiment, the display 13 is designed to provide information security and to promote HIPAA compliance. For example, computer viewing monitors that blur or black out the displayed image outside of a twenty-five degree wide viewing range are manufactured by American Computer Optics.

This corporation presently manufactures three lines of high quality computer privacy screen, for CRT Monitors and Flat Panel Displays, available through InVision Hospital Privacy Screens, 27111 Aliso Creek Rd #150, Aliso Viejo, Calif. 92656. Use of privacy screens insures that only the intended viewer sees confidential information displayed on the screen. All three lines of privacy screens, Standard Blur, Double Axis and Blackout, are intended to meet HIPAA regulations for protecting patient privacy.

In one embodiment, the system 10 is coupled to an external interconnection 17 via a data path 18. In one embodiment, the data path 18 includes an intranet. In one embodiment, the data path 18 includes a local area network (LAN) or wide area network (WAN). In one embodiment, the data path 18 includes access to the Internet via a firewall 19.

Security is a constant challenge for networks and computing engineers responsible for networks, and is discussed in commonly-assigned U.S. Pat. No. 6,192,410 B1, entitled “Methods And Structures For Robust, Reliable file Exchange Between Secured Systems”, issued to Miller et al. and which is hereby incorporated herein by reference. In particular, and as discussed in the afore-noted patent, it is important in wide area network applications for computing systems attached to such a network to secure their resources from inappropriate, unauthorized access. The Internet is an example of a global wide area network where security measures are often critical to an ongoing business enterprise connected to the Internet. Such security measures are required to assure that unauthorized third parties, anywhere in the world, cannot gain access to sensitive materials within the enterprise via the global, publicly accessible, Internet.

Though such security measures or firewalls 19 are vital to secure each particular enterprise, their very existence creates a burden for those trying to legitimately exchange information between enterprises via such global, public networks. A user in one particular computing enterprise encounters a number of difficulties exchanging data with another user in a different computing enterprise via computer system to computer system network communication links. Though the communication capability may exist, for example via the Internet, safeguards and security measures (firewalls 19) within each enterprise makes such enterprise-to-enterprise exchanges difficult—exactly as they are intended to do.

In general, such firewall 19 security measures operate at lower layers of the network communication layered model to filter out potentially harmful network data exchange. For example, the firewall 19 may permit certain protocols to be exchanged only among certain network devices known to be physically secured within the enterprise. Network devices not within the permitted scope of secured devices are not permitted to use the filtered protocols. Should such un-authorized devices attempt such communications, the firewall 19 simply discards their network data transfer requests. As a result, a vendor may not be able to initiate data communications between a database maintained by the vendor and devices that have been deployed at clients of that vendor or allied vendors.

In one embodiment, the data path 18 includes common gateway interface (CGI) data communication capability. In one embodiment, the data path 18 includes an email capability (e.g., simple mail transfer protocol or SMTP) for facilitating data communication. In one embodiment, the data path 18 includes a secure data path using HTTP (hyper text transfer protocol) with SSL (secure sockets layer), as is described in more detail in U.S. Pat. No. 5,657,390, entitled “Secure Socket Layer Application Program Apparatus And Method”, issued to Elgamal et al. and U.S. Pat. No. 6,081,900, entitled “Secure Intranet Access”, issued to Subramanian et al., which patents are hereby incorporated herein by reference for their teachings.

Other features of the system include, without limitation, the following:

A user (the Sender) may deposit a confidential record such as a medical record in a secure, on-line, web-accessible location such as an electronic mailbox. The medical record is intended to be used by one or more Recipients. Senders may accomplish this by logging into the secure site via a secure connection such as a conventional 128-bit encrypted SSL connection.

The system then sends a Notice to the intended Recipients advising them of the existence of a confidential record in their electronic mailbox and advising them that they can log into the secure site to review the Secure Confidential Record. This Notice may be sent in any suitable way, which may include, without limitation, by email, telephone, cell phone, pager, fax, wireless personal digital assistant or PDA, instant messenger, private radio link and the like. Since the Notice contains no confidential or medical information, it may be delivered via widely-available, non-encrypted services. In one embodiment, the Notices are plaintext messages, in other words, the Notices comprise unencrypted, non-secure messages that may be sent using any known communication modality. In one embodiment, messages may be graded according to urgency or priority, e.g., may be graded High, Normal or Low priority.

In one embodiment, the Recipient may preselect options relative to Notices. In other words, the Recipient may predetermine that high priority messages are sent by one or more messaging protocols that will provide notice to the recipient, for example, a telephone call and/or a facsimile, while lower priority messages may be sent via less intrusive techniques such as email. In one embodiment, messages may be grouped by type, for example, appointment request, clinical data, patient referral letter or report, prescription data to the pharmacy or notice to the patient that a prescription is ready and the like.

For example, insurance companies providing health insurance coverage may need to verify that certain expenses are within the ambit of insurance coverage. Alternatively, hospitals and other health care providers may need to consolidate expenses associated with one patient but coming from multiple departments within the hospital. These organizations may get hundreds or thousands of such messages daily, but the messages need not be responded to with any particular rapidity. As a result, these organizations may prefer that kinds of messages do not result in a high priority Notice.

On the other hand, Notices informing a doctor about confidential records including medical imaging from an emergency room or associated with a patient in an intensive care unit may need to carry a high priority. For example, the doctor may well want to be made aware of such Notices via a paging device or cell phone at the earliest possible moment.

Recipients, once they receive a Notice, can log into an electronic mailbox on the system via SSL using a predetermined encryption key or password using, for example, a web browser and the Internet, read the confidential record in a format known as “MxMail”, and can then forward a Notice regarding the confidential record to other authorized secure site users, or save the Notice for later reference. The message including the confidential data does not leave the secure server.

All confidential records and copies of Notices may be permanently stored on the system to create an archived, transactional database of the medical message activity. This may be associated with an audit trail for tracking each and every accession to the confidential information, who accessed the confidential information, when it was accessed and for how long and the like. In one embodiment, the Notices, confidential records and/or audit trail may be further encrypted prior to storage in the database. An exemplary encryption algorithm is known as PGP or if“pretty good protection”.

When patients initially create an account with the system, they identify the healthcare and related organizations that provide them with services. The system then creates an address book for the patient that contains the MxMail addresses of these organizations. Conversely, it also adds the patient's MxMail address to the address book for each of the healthcare and related organizations. In one embodiment, the healthcare organization can manage the address book and MxMail accounts for staff members via a web-based administration application. This application may also provide for management of MxMail users, user groups, user privileges, address books, message notification features, message types and message forms.

System administration also is organized so that MxMail Notices can only be sent to pre-determined users in the MxMail system. For example, patients cannot send Notices to other patients, only to their healthcare providers.

The MxMail databases are stored behind multiple tiers of protection including a firewall protection system, and may use additional data encryption techniques to protect the privacy of the data in the database. The only access to the MxMail confidential records is via a password protected encrypted connection, such as a 128 bit SSL connection, or other encryption as required by applicable Federal or State regulations. Physical security at the site housing the servers is another tier of protection. Proprietary or conventional encryption techniques, such as PGP, may be employed for confidential data encryption of data stored in the database 14, even when confidential data are being exchanged between servers within the secure system.

Attachments are allowed on all confidential records. Senders may attach images, lab results, electronic medical records, prescriptions, or other medically-related files. Examples would include reports from consulting specialists, filled prescriptions, doctor notes describing a doctor-patient visit and the like. Message types and forms may also be specified and used. For example, a patient wanting to request an appointment may access an appointment request form having predetermined data fields. When the data fields are completed by the requester, the form is attached to the MxMail message and is stored, with a Notice being sent to the appropriate recipient or recipients.

When a patient joins the system their address is automatically added to their healthcare providers' address book(s).

The system allows users to track the read status of sent Notices, to assist in monitoring and management of critical healthcare information and also contributing to audit data. The system also creates an audit trail showing who accessed what confidential data, when and how often. The audit trail may be augmented with additional data on each successive accession of the information.

The system may be personalized to display the healthcare provider organization name.

The system further creates and stores an audit trail that is associated with each confidential record. The audit trail allows independent review of who accessed each confidential record, when each confidential record was accessed and the number of times each confidential record was accessed. The audit trail is augmented with additional data describing each successive accession of each confidential record, allowing unambiguous determination of the identity, date and time and duration of each review of the confidential record as well as tracking what portions of each confidential record were reviewed.

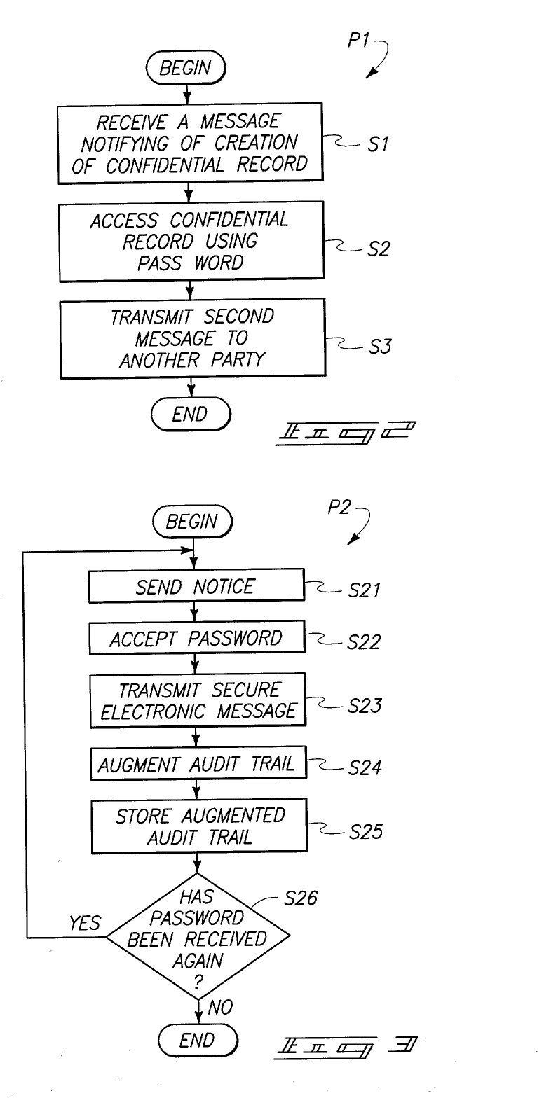

FIG. 2 is a flow chart describing a process P1 for reviewing confidential data using a computer system such as the one of FIG. 1, in accordance with an embodiment of the present invention. The process P1 begins in a step S1.

In the step S1, the process P1 receives a message including notification that a confidential record has been created. In one embodiment, the confidential record includes medical information relative to a specific patient. In one embodiment, the message comprises a plaintext message. In one embodiment, the message includes data message specifying a particular portion of the confidential record. In one embodiment, the message includes indicia of degree of priority, and further the message is delivered via one or more protocols that have been preselected according to degree of priority.

In a step S2, the process P1 accesses the confidential record using a predetermined protocol and password. In one embodiment, the confidential record is accessed via a web server using a 128-bit SSL protocol. In one embodiment, the confidential record is accessed by sending a data review request that is configured to cause a processor associated with confidential data in a database to locate confidential data relating to a specific condition or time period and a specific individual, unencrypt the confidential data and provide an electronic message representing the confidential data via a secure web connection. In one embodiment, the password is configured to facilitate identification of the accessing party or organization in an audit log associated with the confidential record.

In one embodiment, the confidential record is accessed using a predetermined protocol and password and this includes accessing data related to medical records pertinent to a specific patient, wherein the password includes indicia identifying the accessing party or organization and the confidential record includes indicia identifying the specific patient.

In one embodiment, the process P1 includes a step S3 of transmitting a second message to advise another party of need to review data related to the confidential record, in response to accessing. The process P1 then ends.

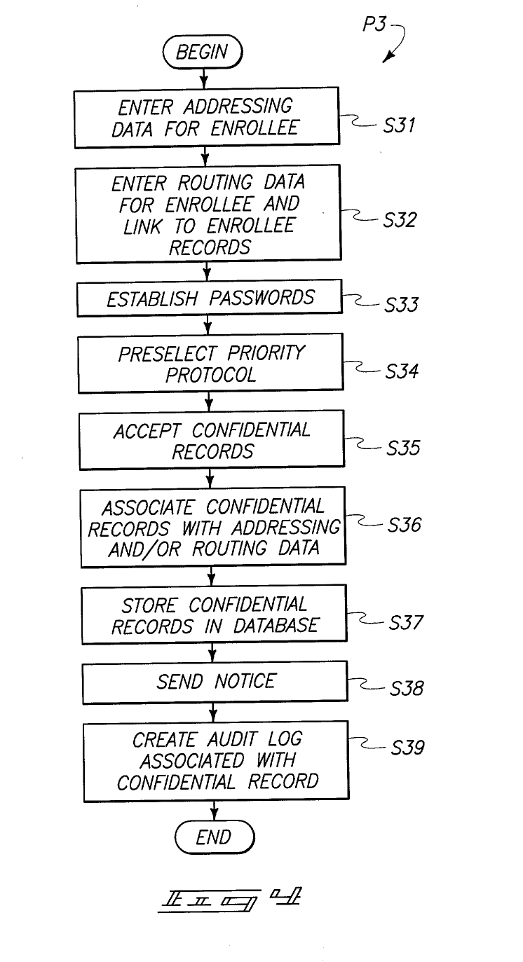

FIG. 3 is a flow chart describing a process P2 for rendering confidential data available for review using a computer system such as the one of FIG. 1, in accordance with an embodiment of the present invention. The process P2 begins with a step S21.

In the step S21, the process P2 sends a Notice to an intended recipient to advise them of the existence of a confidential record in an electronic mailbox associated with the intended recipient. In one embodiment, the Notice is a plaintext message and may optionally include indicia associated with a specific portion of a specific confidential record. In one embodiment, the confidential record includes indicia associated with a specific patient having medical data embodied in the confidential record. In one embodiment, the Notice includes indicia of degree of priority, and further wherein the message is delivered via one or more protocols that have been preselected according to degree of priority.

In a step S22, the process P2 accepts a password associated with the electronic mailbox containing the confidential record in response to having sent the notice. In one embodiment, the password is configured to include indicia associated with the intended recipient.

In a step S23, the process P2 transmits an electronic signal representing the confidential record over a secure web connection. In one embodiment, the step S23 includes locating encrypted data corresponding to the confidential record in an encrypted computer database in response to receiving the password and decrypting the encrypted data to provide data corresponding to the electronic message.

In a step S24, the process P2 augments an audit trail associated with the confidential record. In one embodiment, the audit trail associated with the confidential record includes data indicative of an identity of a party associated with the password, the confidential record accessed, time, date and duration of access

In a step S25, the process P2 stores the audit trail in association with the confidential record in the encrypted database.

In a query task S26, the process P2 determines when the password have been received again. When the process P2 determines that the password has not been received again, the process P2 ends. When the process P2 determines that the password has been received again, the steps S23 through S26 are iterated, and the process P2 ends when the query task S26 determines that the password has not been received anew.

FIG. 4 is a flow chart describing a process P3 for creating a new entry in a secure database, in accordance with an embodiment of the present invention.

The process P3 begins in a step S31. In the step S31, the process enters addressing data specific to a particular person or enrollee in an address table stored on a computer database.

In a step S32, the process P3 enters data allowing routing of messages to one or more parties associated with healthcare for the particular person in the address table. In the step S32, the process P3 also links these data to confidential records associated with the particular person.

In a step S33, the process P3 establishes passwords configured to allow access to confidential records for the particular person. The passwords are also configured to provide indicia permitting identification of the one or more parties when the one or more parties access the confidential records for security and audit purposes.

In a step S34, the process P3 preselects, in response to data input by the one or more parties, one or more protocols according to degree of priority associated with notices that may be transmitted to the one or more parties to advise them of information for their review in the confidential record.

In a step S35, the process P3 accepts confidential records relevant to the particular person.

In a step S36, the process P3 associates the confidential records with the addressing data and/or the routing data.

In a step S37, the process P3 stores the confidential records in a secure database.

In a step S38, the process P3 sends a Notice to a selected one of the one or more parties to advise them of the existence of the confidential records. Optionally, the Notice specifies a particular portion of the confidential record.

In a step S39, the process P3 creates an audit log associated with the confidential record. The process P3 then ends.

The above-described embodiments provide many advantages over and improve upon the current state of the art. For example, the system is secure so that medical information cannot be compromised. In addition, the system requires no software installation by the users. The system is fairly simple to use and can be accessed from any web-based computer in the world. This greatly enhances the flexibility of the system and provides a convenient user experience. Furthermore, physicians can confidently communicate with their patients with no fear of loss of privacy. Clinics can gain the immediate benefit of dramatic improvements in the efficiency and effectiveness of patient communications. Additionally, the service can be provided at no cost to the patient. In addition, hospitals, clinics and payors can use the service to build their local healthcare “community”. The system can create “outreach” opportunities for the Providers—i.e., “it is time for your six month checkup”.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A process for reviewing confidential data comprising:
receiving a message including notification that a confidential record has been created; and
accessing the confidential record using a predetermined protocol and password.

2. The process of claim 1, wherein the confidential record includes medical information.

3. The process of claim 1, wherein receiving a message comprises receiving a plaintext message.

4. The process of claim 1, wherein receiving a message comprises receiving a message by one or more messaging technologies chosen from a group consisting of email, telephone, cell phone, pager, fax, wireless personal digital assistant or PDA, instant messenger and private radio link.

5. The process of claim 1, wherein accessing comprises accessing via a web server using a 128-bit SSL protocol, and wherein accessing further comprises:
sending a data review request that is configured to cause a processor associated with confidential data in a database to:
locate confidential data relating to a specific condition or time period and a specific individual;
unencrypt the confidential data; and
provide an electronic message representing the confidential data via a secure web connection.

6. The process of claim 1, wherein accessing the confidential record using a predetermined protocol and password comprises accessing data related to medical records pertinent to a specific patient, wherein the password includes indicia identifying the accessing party or organization and the confidential record includes indicia identifying the specific patient.

7. The process of claim 1, wherein receiving a message includes receiving a message specifying a particular portion of the confidential record.

8. The process of claim 1, wherein accessing the confidential record using a predetermined protocol and password comprises accessing data associated with medical records pertinent to a specific patient, wherein the password includes indicia identifying the accessing party or organization and the confidential record includes indicia identifying the specific patient, and wherein the password is configured to facilitate identification of the accessing party or organization in an audit log associated with the confidential record.

9. The process of claim 1, wherein receiving a message comprises receiving a message including indicia of degree of priority, and further wherein the message is delivered via one or more protocols that have been preselected according to degree of priority, wherein the protocols are chosen from a group consisting of email, telephone, cell phone, pager, fax, wireless personal digital assistant or PDA, instant messenger and private radio link.

10. The process of claim 1, wherein receiving a message comprises receiving a message including indicia of degree of priority, and further wherein the message is delivered via one or more protocols that have been preselected according to degree of priority.

11. The process of claim 1, further comprising, transmitting a second message to advise another party of need to review data related to the confidential record, in response to accessing.

12. A process for rendering confidential data available for review comprising:
sending a notice to an intended recipient to advise them of the existence of a confidential record in an electronic mailbox associated with the intended recipient;
receiving a password associated with the electronic mailbox containing the confidential record in response to sending; and
transmitting an electronic signal representing the confidential record over a secure web connection.

13. The process of claim 12, wherein transmitting comprises:
locating encrypted data corresponding to the confidential record in an encrypted computer database in response to receiving the password;
decrypting the encrypted data to provide data corresponding to the electronic message;
augmenting an audit trail associated with the confidential record; and
storing the audit trail in association with the confidential record in the encrypted database.

14. The process of claim 12, wherein transmitting comprises:
locating encrypted data corresponding to the confidential record in an encrypted computer database located in a physically-secure facility in response to receiving the password;
decrypting the encrypted data to provide data corresponding to the electronic message;
augmenting an audit trail associated with the confidential record; and
storing the audit trail in association with the confidential record in the encrypted database, the process further comprising:
receiving the password again;
locating the encrypted data again;
decrypting the encrypted data again;
augmenting the audit trail; and
storing the augmented audit trail in association with the encrypted data.

15. The process of claim 12, wherein sending comprises sending a plaintext message including indicia associated with a specific portion of a specific confidential record.

16. The process of claim 12, wherein sending comprises sending a plaintext message and wherein the confidential record includes indicia associated with a specific patient having medical data embodied in the confidential record.

17. The process of claim 12, wherein sending comprises sending a message including indicia of degree of priority, and further wherein the message is delivered via one or more protocols that have been preselected according to degree of priority.

18. The process of claim 12, wherein sending comprises sending a message including indicia of degree of priority, and further wherein the message is delivered via one or more protocols that have been preselected according to degree of priority, chosen from a group consisting of email, telephone, cell phone, pager, fax, wireless personal digital assistant or PDA, instant messenger and private radio link.

19. The process of claim 12, wherein receiving comprises receiving a password that is configured to include indicia associated with the intended recipient.

20. The process of claim 12, wherein transmitting comprises:
augmenting an audit trail associated with the confidential record with data indicative of an identity of a party associated with the password, the confidential record accessed, time, date and duration of access; and
storing the audit trail in association with the confidential record in an encrypted database.

21. The process of claim 12, wherein sending a notice comprises sending a notice including indicia of degree of priority, and further wherein the message is delivered via one or more protocols that have been preselected according to degree of priority.

22. The process of claim 12, wherein sending comprises sending a plaintext message, wherein the confidential record includes indicia associated with a specific patient having medical data embodied in the confidential record, the message including indicia of degree of priority, and further wherein the message is delivered via one or more protocols that have been preselected according to degree of priority.

23. A process for creating a new entry in a secure database comprising:
entering addressing data specific to a particular person in an address table stored on a computer database;
entering data allowing routing of messages to one or more parties associated with healthcare for the particular person in the address table and linked to confidential records associated with the particular person; and
establishing passwords configured to allow access to confidential records for the particular person, wherein the passwords are configured to provide indicia permitting identification of the one or more parties when the one or more parties access the confidential records for security and audit purposes.

24. The process of claim 23, further comprising preselecting, by the one or more parties, one or more protocols according to degree of priority associated with notices that may be transmitted to the one or more parties to advise them of information for their review in the confidential record.

25. The process of claim 23, further comprising:
accepting confidential records relevant to the particular person;
associating the confidential records with the addressing data;
storing the confidential records in a secure database; and
sending a notice to a selected one of the one or more parties to advise them of the existence of the confidential records.

26. The process of claim 23, further comprising:
accepting confidential records relevant to the particular person;
associating the confidential records with the addressing data;
storing the confidential records in a secure database; and
sending a notice to a selected one of the one or more parties to advise them of the existence of the confidential records, wherein the notice specifies a particular portion of the confidential record.

27. The process of claim 23, further comprising:
accepting confidential records relevant to the particular person, the confidential records comprising medical data;
associating the confidential records with the addressing data;
storing the confidential records in a secure database; and
sending a notice to a selected one of the one or more parties to advise them of the existence of the confidential records, wherein the notice is delivered via one or more protocols that have been preselected according to degree of priority.

28. The process of claim 23, further comprising:
accepting confidential records relevant to the particular person, the confidential records comprising medical data;
associating the confidential records with the addressing data;
storing the confidential records in a secure database; and
sending a notice to a selected one of the one or more parties to advise them of the existence of the confidential records, wherein the notice is delivered via one or more protocols that have been preselected according to degree of priority, chosen from a group consisting of email, telephone, cell phone, pager, fax, wireless personal digital assistant or PDA, instant messenger and private radio link.

29. The process of claim 23, further comprising creating an audit log associated with the confidential record.

30. A process of communicating medical data between parties comprising:
receiving a request to access a secure database via a secure web connection;
accepting first predetermined data indicative of an electronic mailbox and second predetermined data indicative of a confidential record comprising medical data relevant to a specific patient; and
transmitting an electronic signal representing a portion of the confidential record over the secure web connection.

31. The process of claim 30, wherein receiving and accepting further comprises accepting data indicative of an identity of a party originating the request, and further comprising augmenting an audit log with information descriptive of the identity, the date, a duration during which the confidential record was reviewed and those portions of the confidential record that were transmitted.

32. An article of manufacture comprising a computer readable medium having computer readable code embodied therein for a process for rendering confidential data available for review that is configured to cause a processor to:
send a notice to an intended recipient to advise them of the existence of a confidential record in an electronic mailbox associated with the intended recipient;
receive a password associated with the electronic mailbox containing the confidential record in response to sending; and
transmit an electronic signal representing the confidential record over a secure web connection.

33. The article of manufacture of claim 32, wherein the computer readable code configured to cause the processor to transmit comprises computer readable code configured to cause the processor to:
locate encrypted data corresponding to the confidential record in an encrypted computer database in response to the processor receiving the password;
decrypt the encrypted data to provide data corresponding to the electronic message;
augment an audit trail associated with the confidential record; and
store the audit trail in association with the confidential record in the encrypted database.

34. The article of manufacture of claim 32, wherein the computer readable code configured to cause the processor to transmit comprises computer readable code configured to cause the processor to:
locate encrypted data corresponding to the confidential record in an encrypted computer database located in a physically-secure facility in response to the processor receiving the password;
decrypt the encrypted data to provide data corresponding to the electronic message;
augment an audit trail associated with the confidential record; and
store the audit trail in association with the confidential record in the encrypted database, the computer readable code further comprises computer readable code configured to cause the processor to:
receive the password again;
locate the encrypted data again;
decrypt the encrypted data again;
augment the audit trail; and
store the augmented audit trail in association with the encrypted data.

35. The article of manufacture of claim 32, wherein the computer readable code configured to send the notice comprises computer readable code configured to cause the processor to send a plaintext message including indicia associated with a specific portion of a specific confidential record.

36. The article of manufacture of claim 32, wherein the computer readable code configured to send the notice comprises computer readable code configured to cause the processor to send a plaintext message and wherein the confidential record includes indicia associated with a specific patient having medical data embodied in the confidential record.

37. The article of manufacture of claim 32, wherein the computer readable code configured to cause the processor to receive comprises computer readable code configured to cause the processor to receive a password that is configured to include indicia associated with the intended recipient.

38. The article of manufacture of claim 32, wherein the computer readable code configured to cause the processor to transmit comprises computer readable code configured to cause the processor to:
augment an audit trail associated with the confidential record with data indicative of an identity of a party associated with the password, the confidential record accessed, time, date and duration of access; and
store the audit trail in association with the confidential record in an encrypted database.

39. The article of manufacture of claim 32, wherein the computer readable code configured to send the notice comprises computer readable code configured to cause the processor to send a notice including indicia of degree of priority, and further wherein the message is sent via one or more protocols that have been preselected according to degree of priority.

40. The article of manufacture of claim 32, wherein the computer readable code configured to send the notice comprises computer readable code configured to cause the processor to send a plaintext message, wherein the confidential record includes indicia associated with a specific patient having medical data embodied in the confidential record, the message including indicia of degree of priority, and further wherein the message is delivered via one or more protocols that have been preselected according to degree of priority.

41. The article of manufacture of claim 32, wherein the computer readable code configured to send the notice comprises computer readable code configured to cause the processor to send a plaintext message, wherein the confidential record includes indicia associated with a specific patient having medical data embodied in the confidential record, the message including indicia of degree of priority, and further wherein the message is delivered via one or more protocols that have been preselected according to degree of priority, chosen from a group consisting of email, telephone, cell phone, pager, fax, wireless personal digital assistant or PDA, instant messenger and private radio link.

42. An article of manufacture comprising a computer readable medium having computer readable code embodied therein for a process for creating a new entry in a secure database that is configured to cause a processor to:
enter addressing data specific to a particular person in an address table stored on a computer database;
enter data allowing routing of messages to one or more parties associated with healthcare for the particular person in the address table and linked to confidential records associated with the particular person; and
establish passwords configured to allow access to confidential records for the particular person, wherein the passwords are configured to provide indicia permitting identification of the one or more parties when the one or more parties access the confidential records for security and audit purposes.

43. The article of manufacture of claim 42, further comprising computer readable code that is configured to cause the processor to preselect, in response to input data from the one or more parties, one or more protocols according to degree of priority associated with notices that may be transmitted to the one or more parties to advise them of information for their review in the confidential record.

44. The article of manufacture of claim 42, further comprising computer readable code that is configured to cause the processor to:
accept confidential records relevant to the particular person;
associate the confidential records with the addressing data;
store the confidential records in a secure database; and
send a notice to a selected one of the one or more parties to advise them of the existence of the confidential records.

45. The article of manufacture of claim 42, further comprising computer readable code that is configured to cause the processor to:
accept confidential records relevant to the particular person;
associate the confidential records with the addressing data;
store the confidential records in a secure database; and
send a notice to a selected one of the one or more parties to advise them of the existence of the confidential records, wherein the notice specifies a particular portion of the confidential record.

46. The article of manufacture of claim 42, further comprising:
accepting confidential records relevant to the particular person, the confidential records comprising medical data;
associating the confidential records with the addressing data;
storing the confidential records in a secure database; and
sending a notice to a selected one of the one or more parties to advise them of the existence of the confidential records.

47. The article of manufacture of claim 42, further comprising computer readable code that is configured to cause the processor to create an audit log associated with the confidential record.

48. The article of manufacture of claim 42, further comprising computer readable code that is configured to cause the processor to preselect, in response to input data from the one or more parties, one or more protocols according to degree of priority associated with notices that may be transmitted to the one or more parties to advise them of information for their review in the confidential record, chosen from a group consisting of email, telephone, cell phone, pager, fax, wireless personal digital assistant or PDA, instant messenger and private radio link.
